(19) United States
(12) Patent Application Publication
(10) Pub. No.: US 2025/0038976 A1
(43) Pub. Date: Jan. 30, 2025

(54) LATTICE-BASED PROXY SIGNATURE METHOD, APPARATUS AND DEVICE, LATTICE-BASED PROXY SIGNATURE VERIFICATION METHOD, APPARATUS AND DEVICE, AND STORAGE MEDIUM

(71) Applicants: ELECTRIC POWER RESEARCH INSTITUTE, CHINA SOUTHERN POWER GRID, Guangzhou, Guangdong (CN); GUIZHOU POWER GRID CO., LTD., Guiyang, Guizhou (CN)

(72) Inventors: Bin QIAN, Guangzhou, Guangdong (CN); Houpeng HU, Guiyang, Guizhou (CN); Yong XIAO, Guangzhou, Guangdong (CN); Jiaxiang OU, Guiyang, Guizhou (CN); Mi ZHOU, Guangzhou, Guangdong (CN); Pengcheng LI, Guiyang, Guizhou (CN); Yi LUO, Guangzhou, Guangdong (CN); Yanhong XIAO, Guiyang, Guizhou (CN); Ji WANG, Guangzhou, Guangdong (CN); Xin WU, Guiyang, Guizhou (CN); Fusheng LI, Guangzhou, Guangdong (CN); Peilin HE, Guiyang, Guizhou (CN); Xiaoming LIN, Guangzhou, Guangdong (CN); Zhenghao GAO, Guiyang, Guizhou (CN); Jianlin TANG, Guangzhou, Guangdong (CN); Zerui CHEN, Guiyang, Guizhou (CN); Fan ZHANG, Guangzhou, Guangdong (CN); Gaoyi LONG, Guiyang, Guizhou (CN); Qiang CHANG, Guiyang, Guizhou (CN); Qin FENG, Guiyang, Guizhou (CN); Yuanhong CEN, Guiyang, Guizhou (CN)

(73) Assignees: ELECTRIC POWER RESEARCH INSTITUTE, CHINA SOUTHERN POWER GRID, Guangzhou, Guangdong (CN); GUIZHOU POWER GRID CO., LTD., Guiyang, Guizhou (CN)

(21) Appl. No.: 18/574,381

(22) PCT Filed: Aug. 18, 2022
(86) PCT No.: PCT/CN2022/113232

§ 371 Date: Sep. 26, 2024

(30) Foreign Application Priority Data
Apr. 26, 2022 (CN) 202210445891.6

(51) Int. Cl. H04L 9/30; H04L 9/32

(52) U.S. Cl. CPC H04L 9/3093; H04L 9/3255; H04L 9/3268

(57) ABSTRACT

A lattice-based proxy signature method, apparatus and device, a lattice-based proxy signature verification method, apparatus and device, and a storage medium. Polynomials are randomly selected in rings to calculate public and private keys of nodes, and the magnitudes of proxy public and private keys are the same as the magnitudes of public and private keys of an original signer. Therefore, compared with existing proxy signature schemes, the present application has smaller lengths of public and private keys and higher storage efficiency. Proxy signature information generated in the present application shows a signature of the original signer and also shows a signature of a proxy signer. Once a proxy signature is created, the proxy signature cannot be repudiated by the proxy signer, and has strong non-repudiation and strong unforgeability. The proxy signature method has the advantage of resisting quantum computer attack.

This application claims the benefit of Chinese patent application No. 202210445891.6, entitled “LATTICE-BASED PROXY SIGNATURE AND VERIFICATION METHOD, APPARATUS AND DEVICE, AND STORAGE MEDIUM”, filed on Apr. 26, 2022 with the China National Intellectual Property Administration, which is incorporated herein by reference in its entirety.

### FIELD

The present disclosure belongs to the field of signature security, and in particular relates to a lattice-based proxy signature and verification method, apparatus and device, and a storage medium.

### BACKGROUND

Proxy signature scheme is a kind of special digital signature system in which a user called an original signer may delegate his digital signature power to another user called a proxy signer, and a digital signature is generated by the proxy signer on behalf of the original signer. In addition to a basic environment such as e-commerce and e-banking that requires the proxy signature, with the in-depth development of the proxy signature and its various extension forms, the proxy signature may also be applied in many different situations, such as in distributed shared object system, grid computing, mobile agent, distribution network, privacy protection of in-vehicle ad hoc network, cloud computing platform or wireless sensor network.

In many application scenarios, such as a wireless sensor network, a cloud computing platform and a mobile vehicle autonomous network, signatures are often in form of “signature sets” signed for different messages by different users. A verifier is required to receive these different signatures and verify them one by one. However, verifying so many (sometimes enormous) signatures will cost a lot of computing resources and time, and the transmission amount of these signatures is large. An efficient proxy signature algorithm will effectively solve this problem, which is particularly important for limited network and computer resources.

Since Mambo, et al. put forward a concept of proxy signature in 1996, research on proxy signature by cryptographers has emerged one after another. In recent 20 years, proxy signature schemes based on discrete logarithm, prime factor decomposition and elliptic curve discrete logarithm problem have been put forward in succession. These proxy signature schemes are low in algorithm efficiency, difficult to be solved in finite fields, and suffer from a forgery attack from the original signer.

On the other hand, many scholars have studied lattice-based proxy signature methods, but there are still many problems in the existing lattice-based proxy signature methods: the original signer may forge a signature of the proxy signer; a size of a private key of the proxy signer is larger than a size of a private key of the original signer, resulting in low storage efficiency; only a weak proxy signature attribute is provided while non-repudiation of the proxy signer is not provided.

Most of the existing proxy signature schemes mentioned above are based on number theory problems, which may not resist an attack from a quantum computer, and the lattice-based signature schemes may not guarantee a strong proxy attribute. Therefore, these proxy signature schemes are still required to be improved.

### SUMMARY

Based on this, a lattice-based proxy signature and verification method, apparatus and device, and a storage medium are provided according to the present disclosure, to overcome the defects of the conventional technology.

In a first aspect, a lattice-based proxy signature method is provided according to the present disclosure. The method is applied to a first node and includes:
randomly selecting a first polynomial from a first ring, and generating a first public key and a first private key based on the first polynomial;
randomly selecting a second polynomial from a second ring, and calculating a proxy signature polynomial based on the first public key, the first private key and the second polynomial, where the first ring and the second ring are different subset rings of a same ring;
generating a delegation certificate based on a public key of a second node and a valid time range of a proxy signature;
randomly selecting a first signature polynomial from the first ring, and calculating a signature of the delegation certificate based on the first signature polynomial, the first public key and the first private key; and
sending proxy information to the second node for calculating a proxy public key and a proxy private key, to allow the second node to implement proxy signature on a message based on the proxy public key and the proxy private key, where the proxy information includes the proxy signature polynomial, the delegation certificate and the signature of the delegation certificate.

Further, the first ring is determined by:
generating a univariate polynomial set based on input parameters;
selecting polynomials from the univariate polynomial set to form a ring; and
randomly selecting a subset ring of the ring based on the input parameters.

Further, the first ring is specifically determined by:
selecting input parameters (p₁,n₁,k₁), where n₁ is an integer as a power of 2, p₁ is a prime number which modulo 2n₁ is equal to 1, and k₁∈Z;
generating a univariate polynomial set Zₚ_{₁}[x]/(xⁿ^{₁}+1), where Zₚ_{₁}[x] represents a set of all univariate polynomials with a coefficient range of [−(p₁−1)/2, (p₁−1)/2], and zₚ_{₁}[x]/(xⁿ^{₁}+1) represents remaining part of the set zₚ_{₁}[x] except those with a polynomial of (xⁿ^{₁}+1);
selecting, based on the parameters p₁ and n₁, polynomials from the set zₚ_{₁}[x]/(xⁿ^{₁}+1) to form a ring

$${R}^{{{p}_{1}}^{{n}_{1}}} ,$$

where elements in the ring

$${R}^{{{p}_{1}}^{{n}_{1}}}$$

are n₁−1 degree polynomials with the coefficient range of [−(p₁−1)/2, (p₁−1)/2]; and
randomly selecting a subset ring

$${R}_{{k}_{1}}^{{{p}_{1}}^{{n}_{1}}}$$

of the ring

$${R}^{{{p}_{1}}^{{n}_{1}}}$$

based on the parameter k₁, where the ring

$${R}_{{k}_{1}}^{{{p}_{1}}^{{n}_{1}}}$$

includes polynomials with a coefficient range of [−k₁,k₁].

Further, the generating a first public key and a first private key based on the first polynomial includes:
selecting first polynomials

$${s}_{11} , {s}_{12} {⟵}^{\$} {R}_{{k}_{1}}^{{p}_{1}^{{n}_{1}}} and {a}_{1} {⟵}^{\$} {R}^{{p}_{1}^{{n}_{1}}} ;$$

calculating t₁←a₁s₁₁+s₁₂; and
generate the first public key pk₁=(a₁,t₁) and the first private key sk₁=(s₁₁,s₁₂).

Further, the calculating a proxy signature polynomial based on the first public key, the first private key and the second polynomial includes:
calculating r₁ₚ←s₁₁+k₁, r₂ₚ←s₁₂+k₂ and k←a₁k₁+k₂, where (r₁ₚ,r₂ₚ,k) form the proxy signature polynomial, and k₁,k₂ represent the second polynomials.

Further, the randomly selecting a second polynomial from a second ring includes:
selecting a second polynomial

$${k}_{1} , {k}_{2} {⟵}^{\$} {R}_{1}^{{p}_{1}^{{n}_{1}}} ,$$

where

$${R}_{1}^{{p}_{1}^{{n}_{1}}}$$

is a subset ring of

$${R}^{{{p}_{1}}^{{n}_{1}}}$$

which includes polynomials with a coefficient range of [−1,1].

Further, the calculating a signature of the delegation certificate includes:
calculating c₁←H(a₁y₁+y₂,w), where y₁₁,y₁₂ represent the first signature polynomials, w represents the delegation certificate, and H(●) represents a hash function operation;
calculating z₁₁←s₁₁c₁+y₁₁ and z₁₂←s₁₂c₁+y₁₂; and
generating the signature of the delegation certificate based on (z₁₁,z₁₂,c₁).

Further, the input parameters (p₁,n₁,k₁) take optimal solutions of n₁=512, p₁=8383489 and k₁=2¹⁴.

In a second aspect, a lattice-based proxy signature method is provided according to the present disclosure. The method is applied to a second node and includes:
randomly selecting a third polynomial from a third ring, and generating a second public key and a second private key based on the third polynomial;
receiving proxy information sent by a first node, where the proxy information includes a proxy signature polynomial, a delegation certificate and a signature of the delegation certificate;
calculating a proxy public key and a proxy private key based on the proxy signature polynomial and a public key of the first node;
randomly selecting a second signature polynomial from the third ring, and calculating a signature of the proxy information based on the second signature polynomial, the second public key and the second private key;
randomly selecting a third signature polynomial from the third ring, and calculating a proxy signature of a message based on the third signature polynomial, the proxy public key and the proxy private key; and
outputting proxy signature information which includes the delegation certificate, the signature of the delegation certificate, the signature of the proxy information and the proxy signature of the message.

Further, the third ring is determined by:
generating a univariate polynomial set based on input parameters;
selecting polynomials from the univariate polynomial set to form a ring; and
randomly selecting a subset ring of the ring based on the input parameters.

Further, the third ring is specifically determined by:
selecting input parameters (p₂,n₂,k₂), where n₂ is an integer as a power of 2, and p₂ is a prime number which modulo 2n₂ is equal to 1, and k₂∈Z;
generating a univariate polynomial set Zₚ_{₂}[x]/(xⁿ^{₂}+1), where Zₚ_{₂}[x] represents a set of all univariate polynomials with a coefficient range of [−(p₂−1)/2, (p₂−1)/2], and zₚ_{₂}[x]/(xⁿ^{₂}+1) represents remaining part of the set zₚ_{₂}, [x] except those with a polynomial of (xⁿ^{₂}+1);
selecting, based on the parameters p₂ and n₂, polynomials from the set Zₚ_{₂}[x]/(xⁿ^{₂}+1) to form a ring

$${R}^{{{p}_{2}}^{{n}_{2}}} ,$$

where elements in the ring

$${R}^{{{p}_{2}}^{{n}_{2}}}$$

are n₂−1 degree polynomials with the coefficient range of [−(p₂−1)/2, (p₂−1)/2]; and
randomly selecting a subset ring

$${R}_{{k}_{2}}^{{p}_{2}^{{n}_{2}}}$$

of the ring

$${R}^{{p}_{2}^{{n}_{2}}}$$

based on the parameter k₂, where the ring

$${R}_{{k}_{2}}^{{p}_{2}^{{n}_{2}}}$$

includes polynomials with a coefficient range of [−k₂,k₂].

Further, the generating a second public key and a second private key based on the third polynomial includes:
selecting third polynomials

$${s}_{21} , {s}_{22} {⟵}^{\$} {R}_{{k}_{2}}^{{p}_{2}^{{n}_{2}}} and {a}_{2} {⟵}^{\$} {R}^{{p}_{2}^{{n}_{2}}} ;$$

calculating t₂←a₂s₂₁+s₂₂; and
generating the second public key pk₂=(a₂,t₂) and the second private key sk₂=(s₂₁,s₂₂).

Further, the proxy public key and the proxy private key are calculated by:
calculating aₚ=a₁,s₁ₚ=r₁ₚ/2,s₂ₚ=r₂ₚ/2 and tₚ=(t₁+k)/2; and
generating the proxy public key pkₚ=(aₚ,tₚ) and the proxy private key skₚ=(s₁ₚ,s₂ₚ).
(r₁ₚ,r₂ₚ,k) represents the proxy signature polynomial, and (a₁,t₁) represents the public key of the first node.

Further, the calculating a signature of the proxy information includes:
calculating c₂←H(a₂y₂₁+y₂₂,mₚ), where y₂₁,y₂₂ represent the second signature polynomials, m, represents the proxy information, and H(●) represents a hash function operation;
calculating z₂₁←s₂₁c₂+y₂₁ and z₂₂←s₂₂c₂+y₂₂; and
taking (z₂₁,z₂₂,c₂) as the signature of the proxy information.

Further, the calculating a proxy signature of a message includes:
calculating c₃←H(aₚy₃₁+y₃₂,m), where y₃₁,y₃₂ represent the third signature polynomials, m represents the message, and H(●) represents a hash function operation;
calculating z₃₁←s₁ₚc₃+y₃₁ and z₃₂←s₂ₚc₃+y₃₂; and
taking (z₃₁,z₃₂,c₃) as the proxy signature of the message.

Further, the input parameters (p₂,n₂,k₂) take optimal solutions of n₂=512, p₂=8383489 and k₂=2¹⁴.

In a third aspect, a lattice-based proxy signature verification method is provided according to the present disclosure. The method is applied to a verification node and includes:
acquiring a message and proxy signature information;
acquiring public key information which includes a public key of a first node, a public key of a second node and a proxy public key;
verifying validity of the proxy signature information based on the public key information; and
verifying validity of a proxy signature of the message based on the proxy public key.

Further, the verifying validity of the proxy signature information based on the public key information includes:
calculating a counter-signature c₁′ for a signature (z₁₁,z₁₂,c₁) of a delegation certificate based on the public key of the first node, wherein in a case that c₁′ is equal to c₁, it is verified that the proxy signature information is valid, and in a case that is not equal to c₁′, the proxy signature information is invalid and a process of the verifying is ended;
calculating a counter-signature c₂′ for a signature (z₂₁,z₂₂,c₂) of proxy information based on the public key of the second node, wherein in a case that c₂′ is equal to c₂, it is verified that the proxy signature information is valid, and in a case that is not equal to c₃, the proxy signature information is invalid and the process of the verifying is ended; and
verifying whether a valid time range of a proxy signature in the delegation certificate has expired, where in a case that the valid time range of the proxy signature in the delegation certificate has not expired, it is verified that the proxy signature information is valid, and in a case that the valid time range of the proxy signature in the delegation certificate has expired, it is verified that the proxy signature information is invalid.

Further, the verifying validity of a proxy signature of the message based on the proxy public key includes:
calculating a counter-signature c₃′ for the proxy signature (z₃₁,z₃₂,c₃) of the message based on the proxy public key, wherein in a case that c₃′ is equal to c₃, it is verified that the proxy signature of the message is valid, and in a case that c₃′ is not equal to c₃, the proxy signature of the message is invalid.

Further, the counter-signature c₁′ is calculated by the following equation:

$${c}_{1}^{′} = H ( {a}_{1} {z}_{11} + {z}_{12} - {t}_{1} , w ) ,$$

where (a₁,t₁) represents the public key of the first node, and w represents the delegation certificate.

Further, the counter-signature c₂′ is calculated by the following equation:

$${c}_{2}^{′} = H ( {a}_{2} {z}_{21} + {z}_{22} - {t}_{2} , {m}_{p} ) ,$$

where (a₂,t₂) represents the public key of the second node, and mₚ represents the proxy information.

Further, the counter-signature c₃′ is calculated by the following equation:

$${c}_{3}^{′} = H ( {a}_{p} {z}_{31} + {z}_{32} - {t}_{p} , m ) ,$$

where (aₚ,tₚ) represents the proxy public key, and m represents the message.

Further, before calculating the counter-signature c₁′, the method further includes:
verifying whether z₁₁ and z₁₂ belong to

$${R}_{{k}_{1} - 32}^{{p}_{1}^{{n}_{1}}} ,$$

where

$${R}_{{k}_{1} - 32}^{{p}_{1}^{{n}_{1}}}$$

represents a subset ring selected based on input parameters (p₁,n₁,k₁), and elements in the ring

$${R}_{{k}_{1} - 32}^{{p}_{1}^{{n}_{1}}}$$

are polynomials with a coefficient range of [−k₁,k₁]; and in a case that z₁₁ or z₁₂ does not belong to

$${R}_{{k}_{1} - 32}^{{p}_{1}^{{n}_{1}}} ,$$

stopping calculating the counter-signature c₁′.

Further, before calculating the counter-signature c₂′, the method further includes:
verifying whether z₂₁ and z₂₂ belong to

$${R}_{{k}_{2} - 32}^{{p}_{2}^{{n}_{2}}} ,$$

where

$${R}_{{k}_{2} - 32}^{{p}_{2}^{{n}_{2}}}$$

represents a subset ring selected based on input parameters (p₂,n₂,k₂), and elements in the ring

$${R}_{{k}_{2} - 32}^{{p}_{2}^{{n}_{2}}}$$

are polynomials with a coefficient range of [−k₂,k₂]; and in a case that z₂₁ or z₂₂ does not belong to

$${R}_{{k}_{2} - 32}^{{p}_{2}^{{n}_{2}}} ,$$

stopping calculating the counter-signature c₂′.

Further, before calculating the counter-signature c₃′, the method further includes:
verifying whether z₃₁ and z₃₂ belong to

$${R}_{{k}_{2} - 32}^{{p}_{2}^{{n}_{2}}} ,$$

where

$${R}_{{k}_{2} - 32}^{{p}_{2}^{{n}_{2}}}$$

represents a subset ring selected based on input parameters (p₂,n₂,k₂), and elements in the ring

$${R}_{{k}_{2} - 32}^{{p}_{2}^{{n}_{2}}}$$

are polynomials with a coefficient range of [−k₂,k₂]; and in a case that z₃₁ or z₃₂ does not belong to

$${R}_{{k}_{2} - 32}^{{p}_{2}^{{n}_{2}}} ,$$

stopping calculating the counter-signature c₃′.

In a fourth aspect, a lattice-based proxy signature apparatus is provided according to the present disclosure. The apparatus includes a first polynomial generation module, a first key generation module, a delegation certificate generation module and a first signature calculation module.

The first polynomial generation module is configured to generate polynomials.

The first key generation module is configured to generate a public key and a private key.

The delegation certificate generation module is configured to generate a delegation certificate.

The first signature calculation module is configured to calculate a signature.

The proxy signature apparatus including the above modules is configured to implement the lattice-based proxy signature method according to the first aspect of the present disclosure.

In a fifth aspect, a lattice-based proxy signature apparatus is provided according to the present disclosure. The apparatus includes a second polynomial generation module, a second key generation module and a second signature calculation module.

The second polynomial generation module is configured to generate polynomials.

The second key generation module is configured to generate a public key and a private key.

The second signature calculation module is configured to calculate a signature.

The proxy signature apparatus including the above modules is configured to implement the lattice-based proxy signature method according to the second aspect of the present disclosure.

In a sixth aspect, a lattice-based proxy signature verification apparatus is provided according to the present disclosure. The apparatus includes an information acquisition module, a public key acquisition module and a signature verification module.

The information acquisition module is configured to acquire a message and proxy signature information.

The public key acquisition module is configured to acquire public key information which includes a public key of a first node, a public key of a second node and a proxy public key.

The signature verification module is configured to verify validity of the proxy signature information based on the public key information.

The signature verification module is further configured to verify validity of a proxy signature of the message based on the proxy public key.

In a seventh aspect, a lattice-based proxy signature device including a memory storing computer executable instructions and a processor is provided according to the present disclosure. The computer executable instructions, when executed by the processor, cause the proxy signature device to execute the lattice-based proxy signature method according to the first aspect and/or the second aspect.

In an eighth aspect, a lattice-based proxy signature verification device including a memory storing computer executable instructions and a processor is provided according to the present disclosure. The computer executable instructions, when executed by the processor, cause the proxy signature verification device to execute the lattice-based proxy signature verification method according to the third aspect.

In a ninth aspect, a storage medium storing a computer executable program is provided according to the present disclosure. The program is configured to, when being executed, implement the lattice-based proxy signature method according to the first aspect and/or the second aspect.

In a tenth aspect, a storage medium storing a computer executable program is provided according to the present disclosure. The program is configured to, when being executed, implement the lattice-based proxy signature verification method according to the third aspect.

As can be seen from the above technical solutions, the present disclosure has the following beneficial effects.

A lattice-based proxy signature and verification method, apparatus and device, and a storage medium are provided according to the present disclosure. A public key and a private key of a polynomial computing node are randomly selected from a ring. A size of a proxy public key and a proxy private key is the same as a size of a public key and a private key of an original signer. Therefore, compared to the existing proxy signature methods, the public key and the private key are shorter and the storage efficiency is higher. With proxy signature information generated according to the present disclosure, both a signature of the original signer and a signature of a proxy signer are shown. Once a proxy signature is created, the proxy signer cannot deny it, which has strong undeniable and unforgeable properties. The proxy signature method according to the present disclosure has an advantage of resisting attacks from a quantum computer.

### BRIEF DESCRIPTION OF THE DRAWINGS

For more clearly illustrating embodiments of the present disclosure or the technical solutions in the conventional technology, drawings referred to for describing the embodiments or the conventional technology will be briefly described hereinafter. The drawings in the following description are only examples of the present disclosure, and for those skilled in the art, other drawings may be obtained based on the provided drawings without any creative efforts.

FIG. 1 is a schematic diagram of a network architecture according to an embodiment of the present disclosure;

FIG. 2 is a flowchart of a lattice-based proxy signature method according to an embodiment of the present disclosure;

FIG. 3 is a flowchart of a lattice-based proxy signature method according to another embodiment of the present disclosure;

FIG. 4 is a flowchart of a lattice-based proxy signature and verification method according to an embodiment of the present disclosure;

FIG. 5 is a schematic structural diagram of a lattice-based proxy signature apparatus according to an embodiment of the present disclosure;

FIG. 6 is a schematic structural diagram of a lattice-based proxy signature apparatus according to another embodiment of the present disclosure;

FIG. 7 is a schematic structural diagram of a lattice-based proxy signature verification apparatus according to an embodiment of the present disclosure; and

FIG. 8 is a schematic diagram of a hardware structure of a lattice-based proxy signature device according to an embodiment of the present disclosure.

### DETAILED DESCRIPTION

Technical solutions of embodiments of the present disclosure are clearly and completely described hereinafter in conjunction with the drawings of the embodiments of the present disclosure. Apparently, the described embodiments are only some embodiments of the present disclosure, rather than all embodiments. Any other embodiments obtained by those skilled in the art based on the embodiments of the present disclosure without any creative work fall within the protection scope of the present disclosure.

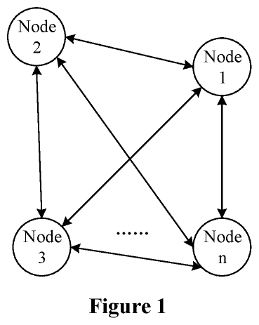

FIG. 1 is a schematic diagram of a network architecture according to an embodiment of the present disclosure. It should be noted that FIG. 1 is only a schematic diagram of a network architecture according to some embodiments of the present disclosure, and other schematic diagrams obtained by optimization or deformation of FIG. 1 fall within the protection scope of the present disclosure.

The network architecture shown in FIG. 1 includes multiple nodes. FIG. 1 shows n nodes. These nodes may be interconnected through a network. The nodes may be represented as servers, intermediate devices, terminal devices and the like. Each of the nodes may represent an original signer or a proxy signer, depending on a service requirement of the node. Of course, a node as the original signer may delegate multiple nodes as proxy signers at the same time. In a case that any two nodes establish proxy delegation communication, they exchange data through an authenticated secure channel to prevent other nodes that are not delegated from receiving key information sent by the node as the original signer.

In order to improve the storage efficiency and the security of a signature, a new lattice-based proxy signature and verification method is provided according to the present disclosure, which improves the algorithms of key generation, signature and verification, and is described here first and then used in various embodiments.

### (1) Key Generation Algorithm Gen:

Input parameters (p,n,k) are set, where n is an integer as a power of 2, p is a prime number which modulo 2n equals to 1, and k∈Z. A univariate polynomial set zₚ[x]/(xⁿ+1) is generated based on the input parameters. zₚ[x] represents a set of all univariate polynomials with a coefficient range of [−(p−1)/2, (p−1)/2], and zₚ[x]/(xⁿ+1) represents remaining part of the set zₚ[x] except those with a polynomial of (xⁿ+1).

Polynomials are randomly selected from the set zₚ[x]/(xⁿ+1) to form a ring R^{p}^{ⁿ}, where elements in the ring R^{p}^{ⁿ} are (n−1) degree polynomials with the coefficient range of [−(p−1)/2, (p−1)/2].

A subset ring Rₖ^{p}^{ⁿ} of the ring R^{p}^{ⁿ} is randomly selected based on the parameter k, where the ring Rₖ^{p}^{ⁿ} comprises polynomials with a coefficient range of [−k,k].

Polynomials

$${s}_{1} , {s}_{2} {←}^{\$} {R}_{k}^{{p}^{n}} and a {←}^{\$} {R}^{{p}^{n}}$$

are randomly selected based on the rings R^{p}^{ⁿ} and Rₖ^{p}^{ⁿ}.
t←as₁+s₂ is calculated, to output a public key pk=(a,t) and a private key sk=(s₁,s₂) of a node.

According to the present disclosure, a hash function is further defined in the algorithm Gen, which is used uniformly in the whole proxy signature process.

The hash function is expressed by H({0,1}*)←D₃₂ⁿ, where D₃₂ⁿ represents a set of univariate (n−1) degree polynomials. Any polynomial has at most 32 coefficients of ±1, and all other coefficients are 0. A hash function operation H(●) is configured to map any message of size of {0,1}* to a polynomial in D₃₂ⁿ.

A specific structure of H(●) is as follows.

{0,1}* is mapped to a 160-bit string, which may be achieved by a commonly used hash operation, such as SHA256. In order to map the 160-bit string to D₃₂ⁿ, a consecutive 5-bit string is viewed each time and is converted into a n/32-bit string with at most one non-zero coefficient. A specific conversion process is as follows.

Let a 5-bit string under viewing be (r1,r2,r3,r4,r5). If r1 is 0, −1 is placed at positions of r2, r3, r4 and r5 in the n/32-bit string. If r1 is 1, 1 is placed at positions of r2, r3, r4 and r5 in the n/32-bit string. Then, a 160-bit string is converted into an n-bit string, and ±1 is in the quantity of at most 32. An i-th coefficient of a polynomial is assigned to an i-th bit of the string, and the n-bit string is converted into a polynomial of at least (n−1) degree. If the degree of the polynomial is greater than n, all the high-order term coefficients will be 0.

(2) Signature Algorithm Sign (m,sk):

In this algorithm, a message m and a private key of a signer sk are input, and a signature result V is output. That is, in a case of signing the message m, two polynomials

$${y}_{1} , {y}_{2} {←}^{\$} {R}_{k}^{{p}^{n}}$$

are randomly selected, c←H(ay₁+y₂,m), z₁←s₁c+y₁ and z₂←s₂c+y₂ are calculated, and the signature result V is (z₁,z₂,c).

Before a signature is generated, it is also checked whether z₁, z₂ are within Rₖ₋₃₂^{p}^{ⁿ} That is, it is required to meet the Ring-LWE (Learning with Errors over Rings) problem, which is limited by a parameter k. If k is too small, it is difficult for z₁, z₂ to appear within Rₖ₋₃₂^{p}^{ⁿ}, and the algorithm Sign is required to be run many times. If k is too large, the system is vulnerable to attacks.

### (3) Verification Algorithm Ver (V,m,pk):

Inputs used are a signature result V, a to-be-verified message m and a public key pk of a signer.

A counter-signature c′=H(az₁+z₂−t,m) is calculated, and whether c′ is equal to c is verified. If c′ is equal to c, 1 is returned to indicate that verification passed, and if c′ is not equal to c, 0 is returned to indicate that the verification failed.

Before calculation, it is also checked whether z₁ and z₂ belong to Rₖ₋₃₂^{p}^{ⁿ}. If z₁ or z₂ does not belong to Rₖ₋₃₂^{p}^{ⁿ}, 0 is returned to indicate that the verification failed.

The above-mentioned key generation algorithm Gen, signature algorithm Sign and verification algorithm Ver may be directly called in the following embodiments.

### Embodiment 1

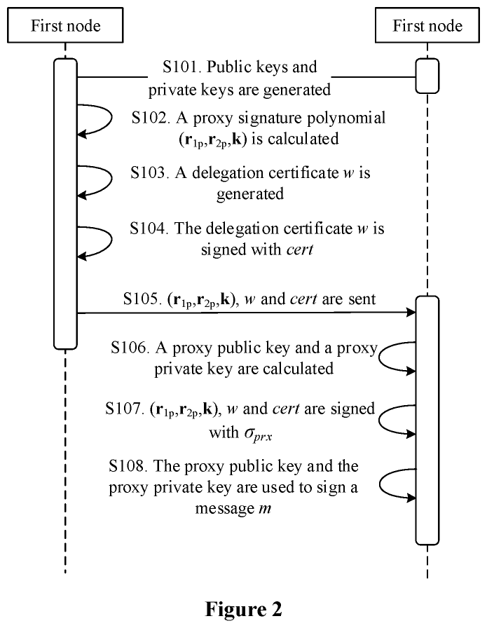

Reference is made to FIG. 2, which shows a lattice-based proxy signature method according to an embodiment, in which a first node delegates a second node for proxy signature.

In S101, the algorithm Gen is called to generate public keys and private keys of the first node and the second node respectively.

It is easy to understand that when generating a public key and a private key of each node, the node itself may call a program in a server to generate the public key and the private key. Alternatively, the node may send a key generation request to the server or to a control end, and the server or the control end may return a generated key to the node. In the embodiment, the node calls an algorithm program to generate the public key and the private key directly.

Therefore, for the first node, a process of calling the algorithm Gen is as follows.

Input parameters (p₁,n₁,k₁) are selected, where n₁ is an integer as a power of 2, p₁ is a prime number which modulo 2n₁ equals to 1, and k₁∈Z. A univariate polynomial set Zₚ_{₁}[x](xⁿ^{₁}−1) is generated, where Zₚ_{₁}[x] represents a set of all univariate polynomials with a coefficient range of [−(p₁−1)/2, (p₁−1)/2], and zₚ_{₁}[x]/(xⁿ^{₁}−1) represents remaining part of the set zₚ_{₁}[x] except those with a polynomial of (xⁿ^{₁}−1). Based on the parameters p₁ and n₁, polynomials are selected from the set zₚ_{₁}[x]/(xⁿ^{₁}−1) to form a ring

$${R}^{{p}_{1}^{{n}_{1}}} ,$$

where elements in the ring

$${R}^{{p}_{1}^{{n}_{1}}}$$

are (n₁−1) degree polynomials with the coefficient range of [−(p₁−1)/2, (p₁−1)/2]. A subset ring

$${R}_{{k}_{1}}^{{p}_{1}^{{n}_{1}}}$$

of the ring

$${R}^{{p}_{1}^{{n}_{1}}}$$

is randomly selected based on the parameter k₁, where the ring

$${R}_{{k}_{1}}^{{p}_{1}^{{n}_{1}}}$$

includes polynomials with a coefficient range of [−k₁,k₁].

Polynomials

$${s}_{11} , {s}_{12} {←}^{\$} {R}_{{k}_{1}}^{{{p}_{1}}^{{n}_{1}}} and {a}_{1} {←}^{\$} {R}^{{{p}_{1}}^{{n}_{1}}}$$

are selected, t₁←a₁s₁₁+s₁₂ is calculated, and the first public key pk₁=(a₁,t₁) and the first private key sk₁=(s₁₁,s₁₂) are generated.

Similarly, for the second node, input parameters (p₂,n₂,k₂) are selected, where n₂ is an integer as a power of 2, p₂ is a prime number which modulo 2n₂ equals to 1, and k₂∈Z. A univariate polynomial set zₚ_{₂}[x]/(xⁿ^{₂}+1) is generated, where Zₚ_{₂}[x] represents a set of all univariate polynomials with a coefficient range of [−(p₂−1)/2, (p₂−1)/2], and zₚ_{₂}[x]/(xⁿ^{₂}+1) represents remaining part of the set Zₚ_{₂}[x] except those with a polynomial of (xⁿ^{₂}+1). Based on the parameters p₂ and n₂, polynomials are selected from the set Zₚ_{₂}[x]/(xⁿ^{₂}+1) to form a ring

$${R}^{{p}_{2}^{{n}_{2}}} ,$$

where elements in the ring

$${R}^{{p}_{2}^{{n}_{2}}}$$

are (n₂−1) degree polynomials with the coefficient range of [−(p₂−1)/2, (p₂−1)/2]. A subset ring

$${R}_{{k}_{2}}^{{p}_{2}^{{n}_{2}}}$$

of the ring

$${R}^{{p}_{2}^{{n}_{2}}}$$

is randomly selected based on the parameter k₂, where the ring

$${R}_{{k}_{2}}^{{p}_{2}^{{n}_{2}}}$$

includes polynomials with a coefficient range of [−k₂,k₂].

Polynomials

$${s}_{21} , {s}_{22} {←}^{\$} {R}_{{k}_{2}}^{{{p}_{2}}^{{n}_{2}}} and {a}_{2} {←}^{\$} {R}^{{{p}_{2}}^{{n}_{2}}}$$

are selected, t₂←a₂s₂₁+s₂₂ is calculated, and the second public key pk₂=(a₂,t₂) and the second private key sk₂=(s₂₁,s₂₂) are generated.

The public key of the node may be broadcast to each node or registered on a bulletin board for disclosure, and the manner for disclosing the public key is not limited in the present disclosure.

In S102, the first node calculates a proxy signature polynomial.

The first node generates two polynomials

$${k}_{1} , {k}_{2} {←}^{\$} {R}_{1}^{{{p}_{1}}^{{n}_{1}}} ,$$

where

$${R}_{{k}_{1}}^{{p}_{1}^{{n}_{1}}}$$

is a subset ring of

$${R}_{{k}_{1}}^{{p}_{1}^{{n}_{1}}} ,$$

which includes polynomials with a coefficient range of [−1,1]. r₁ₚ←s₁₁+k₁ r₂ₚ←s₁₂+k₂ and k←a₁k₁+k₂ are calculated. The proxy signature polynomial is generated based on (r₁ₚ,r₂ₚ, k), where k₁,k₂ are kept by the first node itself and not made public.

In S103, the first node generates a delegation certificate based on the public key of the second node and a valid time range of a proxy signature.

The first node combines its own public key pk₁, the public key pk₂ of the second node and the valid time range t into a long string to generate the delegation certificate w=(pk₁, pk₂,t). t indicates a time period during which the first node delegates the second node for the proxy signature. For example, if the first node restricts that the second node is delegated for the proxy signature only on Mar. 20, 2022, proxy signatures generated by the second node other than this time range are invalid.

In S104, the first node calls the signature algorithm Sign to sign the delegation certificate w, i.e., Sign(w, sk₁)=cert=(z₁₁,z₁₂,c₁).

In S105, the first node sends proxy information to the second node, which includes the proxy signature polynomial (r₁ₚ,r₂ₚ,k), the delegation certificate w and the signature cert.

In S106, the second node calculates a proxy public key and a proxy private key.

The proxy signature polynomial (r₁ₚ, r₂ₚ, k) is received from the first node. aₚ=a₁, s₁ₚ=r₁ₚ/2, s₂ₚ=r₂ₚ/2 and tₚ=(t₁+k)/2 are calculated, where (a₁,t₁) represents the public key of the first node. The proxy public key pkₚ=(aₚ, tₚ) and the proxy private key skₚ=(s₁ₚ,s₂ₚ) are generated.

The establishment of the proxy public key and the proxy private key also has the following relations:

$${t}_{p} = ( {t}_{1} + k ) / 2 = ( {a}_{1} {s}_{12} + {s}_{12} + {a}_{1} {k}_{1} + {j}_{2} ) / 2 = ( {a}_{1} {s}_{11} + {a}_{1} {k}_{1} ) / 2 + ( {s}_{12} + {k}_{2} ) / 2 = {a}_{1} ( {s}_{11} + {k}_{1} ) / 2 + ( {s}_{12} + {k}_{2} ) / 2 = {a}_{1} {r}_{{1}_{p}} + {r}_{{2}_{p}} = {a}_{p} {s}_{1 p} + {s}_{2 p}$$

In S107, the second node calls the signature algorithm Sign to calculate a signature of the proxy information σₚᵣₓ=(z₂₁,z₂₂,c₂).

In the aforementioned information interaction, since the first node keeps k₁,k₂ from making them public, the second node cannot obtain any information about the private key of the first node from the public key of the first node, and any node that obtains the proxy signature polynomial (r₁ₚ,r₂ₚ,k) by eavesdropping or other means cannot calculate the private key of the first node, thus ensuring the security of information.

In S108, using the proxy public key and the proxy private key, the second node calls the signature algorithm Sign to calculate the proxy signature σ(z₃₁,z₃₂,c₃) of the message m, and outputs w, cert and σₚₑₓ together.

### Embodiment 2

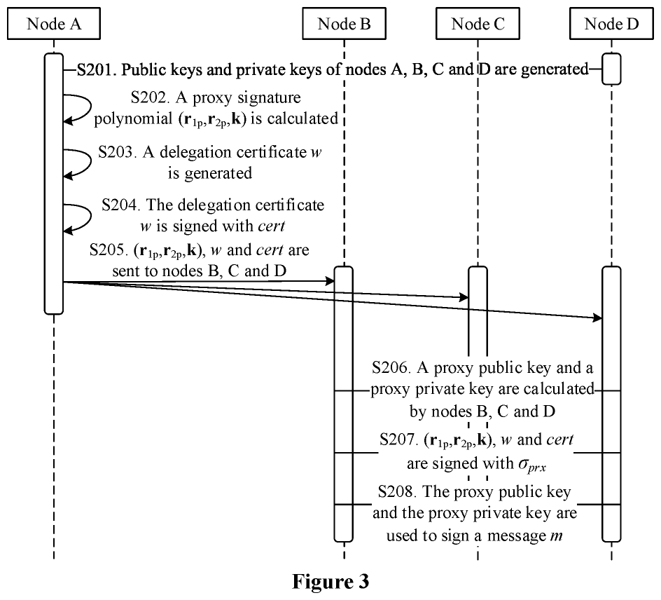

Reference is made to FIG. 3, which shows a lattice-based proxy signature method according to another embodiment, in which an original signer node delegates multiple nodes for proxy signature at the same time.

In the embodiment, the original signature node A delegates nodes B, C and D for proxy signature.

On the basis of Embodiment 1, after generating the delegation certificate and the signature of the delegation certificate, the node A sends the proxy information including the proxy signature polynomial, the delegation certificate and the signature of the delegation certificate through secure channels established with B, C and D respectively. It is easy to understand that steps S201 to S205 in which the node A sends the proxy information to B, C and D are similar to steps S101 to S105 in Embodiment 1, and steps S206 to S208 for implementing proxy signature after the nodes B, C and D receive the proxy information are similar to steps S106 to S108 in Embodiment 1, which are not repeated here.

### Embodiment 3

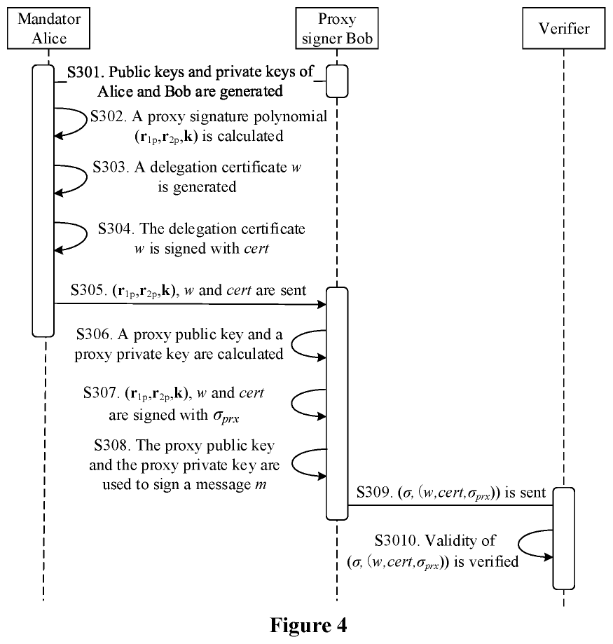

Reference is made to FIG. 4, which shows a lattice-based proxy signature and verification method according to another embodiment, which has a process of verifying a signature.

It is assumed that there are users Alice and Bob, Alice is a mandator, Bob is a proxy signer, and there is a signature verifier.

In S301, public keys and private keys of Alice and Bob are generated.

By calling the previously described key generation algorithm Gen, Alice has a public key (a_{A}, t_{A}) and a private key (s_{1A},s_{2A}), Bob has a public key (a_{B}, t_{B}) and a private key (s_{1B}, s_{2B}), and their public keys are published on a bulletin board.

In S302, Alice calculates a polynomial (r₁ₚ, r₂ₚ, k).

Alice generates two polynomials

$${k}_{1} , {k}_{2} {←}^{\$} {R}_{1}^{{p}^{n}} ,$$

where R₁^{p}^{ⁿ} is a subset ring of R^{p}^{ⁿ}, which includes all polynomials with a coefficient range of [−1,1]. k₁,k₂ are two polynomials randomly selected from the ring. Then, r₁ₚ←s_{1A}+k₁, r₂ₚ←s_{2A}+k₂ and k←a_{A}k₁+k₂ are calculated. Here, the two polynomials k₁,k₂ are kept secret by Alice.

In S303, Alice generates a delegation certificate.

Subsequently, Alice introduces a valid time range t for the delegation, to generate a right delegation certificate w=(pk_{A}, pk_{B}, t), where w refers to combining three parameters pk_{A}, pk_{B},t into a long string, and pk_{A}, pk_{B} represent public keys of Alice and Bob respectively.

In S304, Alice signs the delegation certificate.

Alice calls the aforementioned signature algorithm Sign to sign w to obtain cert, i.e., cert=Sign(w, sk_{A}).

In S305, Alice sends proxy information to Bob.

Alice sends (r₁ₚ,r₂ₚ,k), w and cert to Bob through an authenticated secure channel as the proxy information.

In S306, Bob calculates a proxy public key pkₚ=(aₚ,tₚ) and a proxy private key skₚ=(s₁ₚ,s₂ₚ).

After receiving (rᵢₚ,r₂ₚ,k), w, cert from Alice, Bob calculates aₚ=a_{A},s₁ₚ=r₁ₚ/2 and s₂ₚ=r₂ₚ/2, and then calculates tₚ=(t_{A}+k)/2, where t_{A} is a part of the public key of Alice that Bob obtains from the bulletin board.

In S307, Bob calls the signature algorithm Sign to calculate a signature σₚᵣₓ of the owned information w, cert, pkₚ, i.e., σₚᵣₓ=Sign((w, cert, pkₚ), sk_{B}).

Since Alice keeps k₁,k₂ secretly, the proxy signer Bob cannot derive any information about the private key of the original signer Alice from the public key information pk_{A}=(a_{A} t_{A}) of the original proxy. In addition, anyone that obtains (r₁ₚ,r₂ₚ,k) by eavesdropping or other means (such as Bob leaking information intentionally or unintentionally) cannot calculate the private key of Alice.

In S308, Bob calls the signature algorithm Sign to calculate a proxy signature a for a message m, i.e., σ=Sign(m,skₚ).

In S309, taking w,cert,σₚᵣₓ as another part of a final signature result, Bob sends (σ, (w,cert,σₚᵣₓ)) to the verifier.

In S3010, the verifier receives the message m and (σ, (w,cert,σₚᵣₓ)), and verifies validity of (σ, (w, cert, σₚᵣₓ)).

The message m has been made public in the network, and the verifier may obtain the message m by broadcasting of the message or publishing of the message by a message generation module or the like, which is not further limited in the present disclosure.

Similarly, the verifier may obtain the public keys of Alice and Bob on the bulletin board.

(1) The verification algorithm Ver is called to verify validity of the signature cert for w. That is, it is checked whether Ver(cert,w, pk_{A}) is equal to 1. Specifically, it is to calculate c₁′=H(a_{A}z₁₁+z₁₂−t_{A}, w), where cert=(z₁₁,z₁₂,c₁). If c₁′ is equal to c₁, it means that Ver(cert,w, pk_{A}) is equal to 1. If Ver(cert, w, pk_{A}) is not equal to 1, 0 is returned, and a verification process is ended.

(2) The verification algorithm Ver is called to verify validity of the signature σₚᵣₓ, for (w,cert, pkₚ). That is, it is checked whether Ver(σₚᵣₓ, (w,cert,pkₚ),pk_{B}) is equal to 1. Specifically, it is to calculate c₂′=H(a_{B}z₂₁+z_{y}−t_{D},(w,cert, pk)), where σₚᵣₓ=(z₂₁,z₂₁,c). If c₂′ is equal to c₂ it means that Ver(σₚᵣₓ,(w,cert,pk_{D}),pk_{B}) is equal to 1. If Ver (σₚᵣₓ,(w,cert,pk_{D}),pk_{B}) is not equal to 1, 0 is returned, and a verification process is ended.

(3) It is verified whether the valid time range t of the proxy signature in the delegation certificate w has expired. If the valid time range t of the proxy signature in the delegation certificate w has not expired, verification passed. If the valid time range t of the proxy signature in the delegation certificate w has expired, 0 is returned, and a verification process is ended.

(4) The verification algorithm Ver is called to verify validity of the signature 6 for m. That is, it is checked whether Ver(σ,m,pk_{D}) is equal to 1. Specifically, it is to calculate c₁′=H(aₙz₃₁+z₃₂−tₚ, m), where σ=(z₃₁,z₃₂,c₃). If is equal to, it means that Ver(σ,m,pk_{D}) is equal to 1. If is not equal to 1, 0 is returned, and a verification process is ended.

In addition, if in step (3) t has expired, authorization for proxy signature by Bob is invalid, and Alice may broadcast the signed message m to declare that the delegation certificate w is invalid.

### Embodiment 4

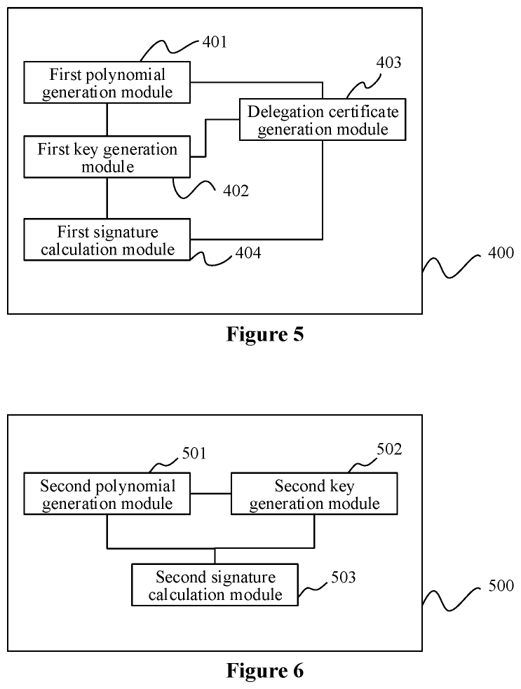

Reference is made to FIG. 5, which shows a lattice-based proxy signature apparatus 400 according to an embodiment. The apparatus 400 includes a first polynomial generation module 401, a first key generation module 402, a delegation certificate generation module 403 and a first signature calculation module 404.

The first polynomial generation module 401 is configured to generate polynomials.

The first key generation module 402 is configured to generate a public key and a private key.

The delegation certificate generation module 403 is configured to generate a delegation certificate based on the polynomials generated in the module 401 and the keys generated in the module 402.

The first signature calculation module 404 is configured to calculate a signature of information.

For an execution process of the first polynomial generation module 401, reference may be made to the process of generating and calculating the polynomials described in the previous embodiments of the present disclosure, which is not repeated here.

For an execution process of the first key generation module 402, reference may be made to the process of generating the keys described in the previous embodiments of the present disclosure, which is not repeated here.

For an execution process of the delegation certificate generation module 403, reference may be made to the process of generating the delegation certificate described in the previous embodiments of the present disclosure, which is not repeated here.

For an execution process of the first signature calculation module 404, reference may be made to the process of calculating the signature described in the previous embodiments of the present disclosure, which is not repeated here.

### Embodiment 5

Reference is made to FIG. 6, which shows a lattice-based proxy signature apparatus 500 according to an embodiment. The apparatus 500 includes a second polynomial generation module 501, a second key generation module 502 and a second signature calculation module 503.

The second polynomial generation module 501 is configured to generate polynomials.

The second key generation module 502 is configured to generate a public key and a private key.

The second signature calculation module 503 is configured to calculate a signature of information.

For an execution process of the second polynomial generation module 501, reference may be made to the process of generating and calculating the polynomials described in the previous embodiments of the present disclosure, which is not repeated here.

For an execution process of the second key generation module 502, reference may be made to the process of generating the key described in the previous embodiments of the present disclosure, which is not repeated here.

For an execution process of the second signature calculation module 503, reference may be made to the process of calculating the signature described in the previous embodiments of the present disclosure, which is not repeated here.

### Embodiment 6

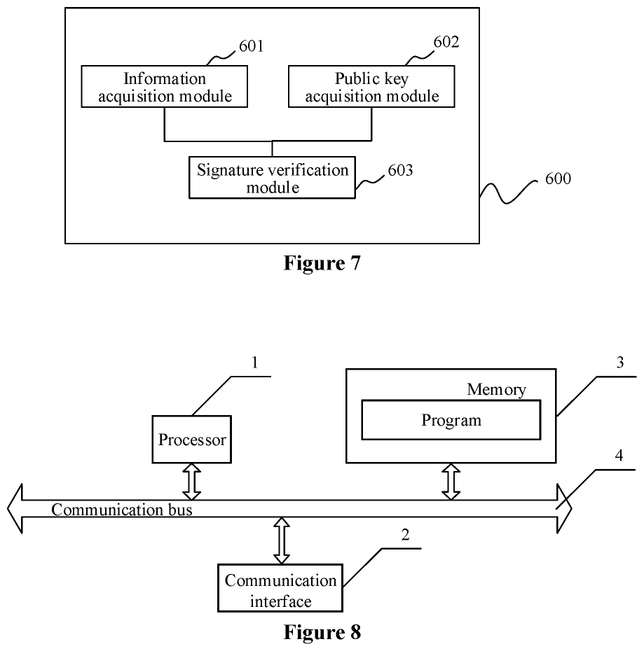

Reference is made to FIG. 7, which shows a lattice-based proxy signature verification apparatus 600 according to an embodiment. The apparatus 600 includes an information acquisition module 601, a public key acquisition module 602 and a signature verification module 603.

The information acquisition module 601 is configured to acquire a message and proxy signature information.

The public key acquisition module 602 is configured to acquire public key information which includes a public key of a first node, a public key of a second node and a proxy public key.

The signature verification module 603 is configured to verify validity of the proxy signature information based on the public key information.

The signature verification module 603 is further configured to verify validity of a proxy signature of the message based on the proxy public key.

For an execution process of the information acquisition module 601, reference may be made to the process of acquiring the message and the proxy signature information described in the previous embodiments of the present disclosure, which is not repeated here.

For an execution process of the public key acquisition module 602, reference may be made to the process of acquiring the public key of the node or the user described in the previous embodiments of the present disclosure, which is not repeated here.

For an execution process of the signature verification module 603, reference may be made to the process of verifying the validity of the signature described in the previous embodiments of the present disclosure, which is not repeated here.

The lattice-based proxy signature method according to the embodiment of the present disclosure may be applied to a lattice-based proxy signature device. The proxy signature device may be an integrated control terminal or general control platform, or may be a control computer integrated with software modules such as random access memory (RAM), internal memory, read-only memory (ROM), electrically programmable ROM, electrically erasable programmable ROM, registers, hard disks, removable disks, CD-ROMs, or any other storage media known in the technical field.

FIG. 8 shows a block diagram of a hardware structure of a proxy signature device, which may include at least one processor 1, at least one communication interface 2, at least one memory 3 and at least one communication bus 4.

In the embodiment of the present disclosure, there is at least one processor 1, at least one communication interface 2, at least one memory 3 and at least one communication bus 4. In addition, the processor 1, the communication interface 2 and the memory 3 communicates with each other through the communication bus 4.

The processor 1 may be a central processing unit (CPU), or an Application Specific Integrated circuit (ASIC), or one or more integrated circuits configured to implement embodiments of the present disclosure.

The memory 3 may include a high-speed RAM memory, or may include a non-volatile memory or the like, such as at least one disk memory.

The memory stores a program, the processor may call the program stored in the memory, and the program is configured to implement the lattice-based proxy signature flow described in the previous embodiments.

Similarly, the lattice-based proxy signature verification method according to the embodiment of the present disclosure may be applied to a lattice-based proxy signature verification device. A hardware structure of the proxy signature verification device may be referred to FIG. 8, which is not repeated here, to implement the lattice-based proxy signature verification flow described in the previous embodiments.

A storage medium storing a computer executable program is further provided according to an embodiment of the present disclosure. The program is executed to implement the lattice-based proxy signature method disclosed in the previous embodiments.

A storage medium storing a computer executable program is further provided according to an embodiment of the present disclosure. The program is executed to implement the lattice-based proxy signature verification method disclosed in the previous embodiments.

### Embodiment 7

In order to further illustrate the security of the proxy signature and verification method according to the present disclosure, an effect comparison with the existing proxy signature method is provided according to an embodiment.

The comparison is made with the conventional proxy signature method described in Chinese patent application 201410159014.8 entitled “LATTICE-BASED PROXY SIGNATURE METHOD AND SYSTEM” (referred to as comparison object).

The proxy public key obtained by the key generation algorithm Gen according to the previous embodiments of the present disclosure includes two univariate n−1 degree polynomials aₚ,tₚ in a ring R^{p}^{ⁿ} , i.e., with a polynomial coefficient range of [−p/2,p/2], each (n−1) degree polynomial has n coefficients, and its length may be calculated as 2n log p. The proxy private key includes two univariate polynomials in a ring R₁^{p}^{ⁿ} i.e., with a polynomial coefficient range of [−1,1], and its length may be calculated as 2n log (3).

The proxy signature according to the present disclosure includes three basic signatures (cert, σₚᵣₓ, σ) and a delegation certificate w, where each of the basic signatures includes two polynomials z₁, z₂ in a ring

$${R}_{k - 32}^{{p}^{n}}$$

and a hash result c (a size of c is approximately equal to n, and n is an integer as a power of 2), and a size of the signature is the sum of bit lengths of z₁, z₂ and c, which may be calculated as 2n log (2(k−32)+1)+n 2n log (2 k)+n. w contains two public keys and a valid time t (which may be ignored), and a size of w is 2n log p. Therefore, a total length of proxy signature information is 6n log(2 k)+n+2n log p.

The public key of the comparison object includes three F_{q}^{m×l} matrices A, T₁ and T₂, where F represents a finite field on q, m represents the number of equations defined by it, m>n, and l represents a positive integer defined by it. The number of elements of each of the matrices is m×1, with an element range of [−q, q]. Therefore, its length may be calculated as 3 ml log(2q+1) bits.

The private key of the comparison object includes a F_{q}^{m×l} matrix s₂. The number of elements of each matrix is m×1, with an element range of [−q, q]. Therefore, its length may be calculated as ml log(2q+1) bits, and its signature includes a vector z on F_{q}^{m} and a hash result c, a size of which is the sum of these bit lengths and may be calculated as m log q+k.

Therefore, a comparison result between the present disclosure and the comparison object are shown in Table 1 below.

TABLE 1

| | Patent application | |
|---|---|---|
| | 201410159014.8 | Present disclosure |
| Computational overhead of | O(n) | O(n) |
| proxy signature process | | |
| Computational overhead of | O(n²) | O(n²) |
| proxy verification process | | |
| Length of proxy private key | mllog (2q + 1) | 2nlog (3) |
| Length of proxy public key | 3mllog (2q + 1) | 2nlogp |
| Length of proxy signature | mlogq + k | 6nlog (2k) + n + |
| | | 2nlogp |

As can be seen from Table 1, compared with the patent application 201410159014.8, with the present disclosure, lengths of the private key and the public key are smaller. Since the value of q in lattice cipher is usually large, if m=n (which is very common in polynomial equation system), the lengths of the public key and the private key according to the present disclosure are reduced by l log(2q+1)/2 log (3) times and l log(2q+1)/log p times respectively. Although the length of proxy signature is increased by about 7 times, the saving of calculation of the public key and the private key may make up for the cost brought by the increase in signature length. At the same time, a strong security proxy signature may also be provided according to the present disclosure.

The above embodiments are only used for illustrating the technical solutions of the present disclosure, and are not intended to limit the present disclosure. Although the present disclosure is illustrated in detail with reference to the embodiments described above, it should be understood by those skilled in the art that modification may be made to the technical solutions recited in the embodiments described above, or equivalent substitution may be made onto a part of technical features of the technical solution. The modifications and equivalent replacements will not make the corresponding technical solutions deviate from the spirit and scope of the technical solutions of the embodiments of the present disclosure.

1. A lattice-based proxy signature method, applied to a first node, comprising:
randomly selecting a first polynomial from a first ring, and generating a first public key and a first private key based on the first polynomial;
randomly selecting a second polynomial from a second ring, and calculating a proxy signature polynomial based on the first public key, the first private key and the second polynomial, wherein the first ring and the second ring are different subset rings of a same ring;
generating a delegation certificate based on a public key of a second node and a valid time range of a proxy signature;
randomly selecting a first signature polynomial from the first ring, and calculating a signature of the delegation certificate based on the first signature polynomial, the first public key and the first private key; and
sending proxy information to the second node for calculating a proxy public key and a proxy private key, to allow the second node to implement proxy signature on a message based on the proxy public key and the proxy private key, wherein the proxy information comprises the proxy signature polynomial, the delegation certificate and the signature of the delegation certificate.

2. The lattice-based proxy signature method according to claim 1, wherein the first ring is determined by:
generating a univariate polynomial set based on input parameters;
selecting polynomials from the univariate polynomial set to form a ring; and
randomly selecting a subset ring of the ring based on the input parameters.

3. The lattice-based proxy signature method according to claim 2, wherein the first ring is determined by:
selecting input parameters (p₁,n₁,k₁), wherein n₁ is an integer as a power of 2, p₁ is a prime number which modulo 2n₁ is equal to 1, and k₁∈Z;
generating the univariate polynomial set Zₚ_{₁}[x]/(xⁿ^{₁}+1), wherein Zₚ _{₁}[x] represents a set of univariate polynomials with a coefficient range of [−(p₁−1)/2, (p₁−1)/2], and zₚ_{₁}, [x]/(xⁿ^{₁}+1) represents remaining part of the set zₚ_{₁} [x] except those with a polynomial of (xⁿ^{₁}+1);
selecting, based on the parameters p₁ and n₁, polynomials from the set zₚ_{₁}[x]/(xⁿ^{₁}+1) to form a ring
$${R}^{{p}_{1}^{{n}_{1}}} ,$$
, wherein elements in the ring
$${R}^{{{p}_{1}}^{{n}_{1}}}$$
are (n₁−1) degree polynomials with the coefficient range of [−(p₁−1)/2, (p₁−1)/2]; and
randomly selecting a subset ring
$${R}_{{k}_{1}}^{{p}_{1}^{{n}_{1}}}$$
of the ring
$${R}^{{p}_{1}^{{n}_{1}}}$$
based on the parameter k₁, wherein the ring
$${R}_{{k}_{1}}^{{p}_{1}^{{n}_{1}}}$$
comprises polynomials with a coefficient range of [−k₁,k₁].

4. The lattice-based proxy signature method according to claim 3, wherein the first public key and the first private key are generated by:
selecting first polynomials
$${s}_{11} , {s}_{12} {←}^{\$} {R}_{{k}_{1}}^{{{p}_{1}}^{{n}_{1}}} and {a}_{1} {←}^{\$} {R}^{{{p}_{1}}^{{n}_{1}}} ;$$
calculating t₁←a₁s₁₁+s₁₂; and
generating the first public key pk₁=(a₁, t₁) and the first private key sk₁=(s₁₁,s₁₂).

5. The lattice-based proxy signature method according to claim 1, wherein the calculating the proxy signature polynomial based on the first public key, the first private key and the second polynomial comprises:
calculating r₁ₚ←s₁₁+k₁, r₂ₚ←s₁₂+k₂ and k←a₁k₁+k₂, wherein (r₁ₚ, r₂ₚ, k) form the proxy signature polynomial, k₁,k₂ represent the second polynomials, a₁ represents a part of the first public key, and (s₁₁,s₁₂) represents the first private key.

6. The lattice-based proxy signature method according to claim 3, wherein the input parameters (p₁,n₁,k₁) take optimal solutions of n₁=512, p₁=8383489 and k₁=2¹⁴.

7. The lattice-based proxy signature method according to claim 1, wherein the signature of the delegation certificate is calculated by:
calculating c₁←H(a₁y₁+y₂,w), wherein y₁₁, y₁₂ represent the first signature polynomials, w represents the delegation certificate, and H(●) represents a hash function operation;
calculating z₁₁←s₁₁c₁+y₁₁ and z₁₂←s₁₂c₁+y₁₂; and
taking (z₁₁,z₁₂, c₁) as the signature of the delegation certificate, wherein a₁ represents a part of the first public key, and (s₁₁,s₁₂) represents the first private key.

8. A lattice-based proxy signature method, applied to a second node, comprising:
randomly selecting a third polynomial from a third ring, and generating a second public key and a second private key based on the third polynomial;
receiving proxy information sent by a first node, wherein the proxy information comprises a proxy signature polynomial, a delegation certificate and a signature of the delegation certificate;
calculating a proxy public key and a proxy private key based on the proxy signature polynomial and a public key of the first node;
randomly selecting a second signature polynomial from the third ring, and calculating a signature of the proxy information based on the second signature polynomial, the second public key and the second private key;
randomly selecting a third signature polynomial from the third ring, and calculating a proxy signature of a message based on the third signature polynomial, the proxy public key and the proxy private key; and
outputting proxy signature information which comprises the delegation certificate, the signature of the delegation certificate, the signature of the proxy information and the proxy signature of the message.

9. The lattice-based proxy signature method according to claim 8, wherein the third ring is determined by:
generating a univariate polynomial set based on input parameters;
selecting polynomials from the univariate polynomial set to form a ring; and
randomly selecting a subset ring of the ring based on the input parameters.

10. The lattice-based proxy signature method according to claim 9, wherein the third ring is determined by:
selecting input parameters (p₂,n₂,k₂), wherein n₂ is an integer as a power of 2, and p₂ is a prime number which modulo 2n₂ is equal to 1, and k₂∈Z;
generating the univariate polynomial set Zₚ_{₁}[x]/(xⁿ^{₁}+1), wherein Zₚ_{₂}[x] represents a set of univariate polynomials with a coefficient range of [−(p₂−1)/2, (p₂−1)/2], and zₚ_{₁}[x]/(xⁿ^{₁}+1) represents remaining part of the set zₚ_{₂}[x] except those with a polynomial of (xⁿ^{₂}+1);
selecting, based on the parameters p₂ and n₂, polynomials from the set zₚ_{₁}[x]/(xⁿ^{₁}+1) to form a ring
$${R}^{{{p}_{2}}^{{n}_{2}}} ,$$
, wherein elements in the ring
$${R}^{{p}_{2}^{{n}_{2}}}$$
are n₂−1 degree polynomials with the coefficient range of [−(p₂−1)/2, (p₂−1)/2]; and
randomly selecting a subset ring
$${R}_{{k}_{2}}^{{{p}_{2}}^{{n}_{2}}}$$
of the ring
$${R}^{{{p}_{2}}^{{n}_{2}}}$$
based on the parameter k₂, wherein the ring
$${R}_{{k}_{2}}^{{{p}_{2}}^{{n}_{2}}}$$
comprises polynomials with a coefficient range of [−k₂,k₂].

11. The lattice-based proxy signature method according to claim 10, wherein the second public key and the second private key are generated by:
selecting third polynomials
$${s}_{21} , {s}_{22} {←}^{\$} {R}_{{k}_{2}}^{{{p}_{2}}^{{n}_{2}}} and {a}_{2} {←}^{\$} {R}^{{{p}_{2}}^{{n}_{2}}} ;$$
calculating t₂←a₂s₂₁+s₂₂; and
generating the second public key pk₂=(a₂,t₂) and the second private key sk₂=(s₂₁,s₂₂).

12. The lattice-based proxy signature method according to claim 10, wherein the input parameters (p₂,n₂,k₂) take optimal solutions of n₂=512, p₂=8383489 and k₂=2¹⁴.

13. The lattice-based proxy signature method according to claim 8, wherein the proxy public key and the proxy private key are calculated by:
calculating aₚ=a₁,s₁ₚ=r₁ₚ/2,s₂ₚ=r₂ₚ/2 and tₚ=(t₁,+k)/2; and
generating the proxy public key pkₚ=(aₚ, tₚ) and the proxy private key skₚ=(s₁ₚ, s₂ₚ),
wherein (r₁ₚ, r₂ₚ, k) represents the proxy signature polynomial, and (a₁, t₁) represents the public key of the first node.

14. The lattice-based proxy signature method according to claim 8, wherein the calculating the signature of the proxy information comprises:
calculating c₂←H(a₂y₂₁+y₂₂, mₚ), wherein y₂₁, y₂₂ represent the second signature polynomials, mₚ represents the proxy information, and H(●) represents a hash function operation;
calculating z₂₁←s₂₁c₂+y₂₁ and z₂₂←s₂₂c₂+y₂₂; and
taking (z₂₁,z₂₂,c₂) as the signature of the proxy information, wherein a₂ represents a part of the second public key, and (s₂₁,s₂₂) represents the second private key.

15. The lattice-based proxy signature method according to claim 8, wherein the calculating a proxy signature of a message comprises:
calculating c₃←H(aₚy₃₁+y₃₂,m), wherein y₃₁, y₃₂ represent the third signature polynomials, m represents the message, and H(●) represents a hash function operation;
calculating z₃₁←s₁ₚc₃+y₃₁ and z₃₂←s₂ₚc₃+y₃₂; and
taking (z₃₁,z₃₂,c₃) as the proxy signature of the message, wherein aₚ represents a part of the proxy public key, and (s₁ₚ,s₂ₚ) represents the proxy private key.

16. A lattice-based proxy signature verification method, applied to a verification node, comprising:
acquiring a message and proxy signature information;
acquiring public key information which comprises a public key of a first node, a public key of a second node and a proxy public key;
verifying validity of the proxy signature information based on the public key information; and
verifying validity of a proxy signature of the message based on the proxy public key.

17. The lattice-based proxy signature verification method according to claim 16, wherein the verifying validity of the proxy signature information based on the public key information comprises:
calculating a counter-signature c₁′ for a signature (z₁₁,z₁₂,c₁) of a delegation certificate based on the public key of the first node, wherein in a case that c₁′ is equal to c₁′, it is verified that the proxy signature information is valid, and in a case that c₁′ is not equal to c₁, the proxy signature information is invalid and a process of the verifying is ended;
calculating a counter-signature c₂′ for a signature (z₂₁,z₂₂,c₂) of proxy information based on the public key of the second node, wherein in a case that c₂′ equal to c₂, it is verified that the proxy signature information is valid, and in a case that c₂′ is not equal to c₂, the proxy signature information is invalid and the process of the verifying is ended; and
verifying whether a valid time range of a proxy signature in the delegation certificate has expired, wherein in a case that the valid time range has not expired, it is verified that the proxy signature information is valid, and in a case that the valid time range has expired, the proxy signature information is invalid.

18. The lattice-based proxy signature verification method according to claim 16, wherein the verifying validity of the proxy signature of the message based on the proxy public key comprises:
calculating a counter-signature c₃′ for the proxy signature (z₃₁,z₃₂,c₃) of the message based on the proxy public key, wherein in a case that c₃′ is equal to c₃, it is verified that the proxy signature of the message is valid, and in a case that is not equal to, the proxy signature of the message is invalid.

19. The lattice-based proxy signature verification method according to claim 17, wherein the counter-signature c₁′ is calculated by the following equation:
$${c}_{1}^{′} = H ( {a}_{1} {z}_{11} + {z}_{12} - {t}_{1} , w ) ,$$
wherein (a₁, t₁) represents the public key of the first node, and w represents the delegation certificate.

20. The lattice-based proxy signature verification method according to claim 17, wherein the counter-signature c₂′ is calculated by the following equation:
$${c}_{2}^{′} = H ( {a}_{2} {z}_{21} + {z}_{22} - {t}_{2} , {m}_{p} ) ,$$
wherein (a₂,t₂) represents the public key of the second node, and mₚ represents the proxy information.

21. The lattice-based proxy signature verification method according to claim 18, wherein the counter-signature c₃′ is calculated by the following equation:
$${c}_{3}^{′} = H ( {a}_{p} {z}_{31} + {z}_{32} - {t}_{p} , m ) ,$$
wherein (aₚ,tₚ) represents the proxy public key, and m represents the message.

22. The lattice-based proxy signature verification method according to claim 17, wherein before calculating the counter-signature c₁′, the method further comprises:
verifying whether z₁₁ and z₁₂ belong to
$${R}_{{k}_{1} - 32}^{{{p}_{1}}^{{n}_{1}}} ,$$
, wherein
$${R}_{{k}_{1} - 32}^{{{p}_{1}}^{{n}_{1}}}$$
represents a subset ring selected based on input parameters (p₁,n₁,k₁), and elements in the ring
$${R}_{{k}_{1} - 32}^{{{p}_{1}}^{{n}_{1}}}$$
are polynomials with a coefficient range of [−k₁,k₁]; and in a case that z₂₁ or z₂₂ does not belong to
$${R}_{{k}_{1} - 32}^{{{p}_{1}}^{{n}_{1}}} ,$$
, stopping calculating the counter-signature c₁′.

23. The lattice-based proxy signature verification method according to claim 17, wherein before calculating the counter-signature c₂′, the method further comprises:
verifying whether z₂₁ and z₂₂ belong to
$${R}_{{k}_{2} - 32}^{{{p}_{2}}^{{n}_{2}}} ,$$
, wherein
$${R}_{{k}_{2} - 32}^{{{p}_{2}}^{{n}_{2}}}$$
represents a subset ring selected based on input parameters (p₂,n₂,k₂), and elements in the ring
$${R}_{{k}_{2} - 32}^{{{p}_{2}}^{{n}_{2}}}$$
are polynomials with a coefficient range of [−k₂,k₂]; and in a case that z₂₁ or z₂₂ does not belong to
$${R}_{{k}_{2} - 32}^{{{p}_{2}}^{{n}_{2}}} ,$$
, stopping calculating the counter-signature c₂′.

24. The lattice-based proxy signature verification method according to claim 18, wherein before calculating the counter-signature c₃′, the method further comprises:
verifying whether z₃₁ and z₃₂ belong to
$${R}_{{k}_{2} - 32}^{{{p}_{2}}^{{n}_{2}}} ,$$
, wherein
$${R}_{{k}_{2} - 32}^{{{p}_{2}}^{{n}_{2}}}$$
represents a subset ring selected based on input parameters (p₂,n₂,k₂), and elements in the ring
$${R}_{{k}_{2} - 32}^{{{p}_{2}}^{{n}_{2}}}$$
are polynomials with a coefficient range of [−k₂,k₂]; and in a case that z₃₁ or z₃₂ does not belong to
$${R}_{{k}_{2} - 32}^{{{p}_{2}}^{{n}_{2}}} ,$$
, stopping calculating the counter-signature c₃′.

25. (canceled)

26. (canceled)

27. (canceled)

28. A lattice-based proxy signature device comprising a memory storing computer executable instructions and a processor, wherein the computer executable instructions, when executed by the processor, cause the proxy signature device to execute the lattice-based proxy signature method according to claim 1.

29. A lattice-based proxy signature verification device comprising a memory storing computer executable instructions and a processor, wherein the computer executable instructions, when executed by the processor, cause the proxy signature verification device to execute the lattice-based proxy signature verification method according to claim 16.

30. (canceled)

31. (canceled)
